(19) United States
(12) Patent Application Publication
(10) Pub. No.: US 2010/0281666 A1
(43) Pub. Date: Nov. 11, 2010

(54) ASSEMBLING DEVICE FOR BED ASSEMBLY

(76) Inventor: Lin-Yao Tseng, Guanyin Township (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/436,247

(22) Filed: May 6, 2009

(51) Int. Cl. B25B 27/14

(52) U.S. Cl. 29/281.1

(57) ABSTRACT

An assembling device for bed assembly, including a main stand, a bracket and a rest assembly. The bracket is fixedly disposed on the main stand and extends from the main stand. At least one support member is disposed on the bracket and upward extends therefrom. The rest assembly is mounted on the bracket and has at least one locating board for conveniently resting one or more bed frames thereon and quickly assembling the bed frames at lower ratio of defective products. After assembled, the bed assembly is conveniently carried away from the assembling device.

### FIELD OF THE INVENTION

The present invention relates generally to an assembling device, and more particularly to an assembling device for bed assembly. With the assembling device, the bed assembly can be quickly assembled at lower ratio of defective products.

### BACKGROUND OF THE INVENTION

It is known that sufficient sleep of good quality can effectively relieve stress on people in modern society. The quality of sleep is a very important factor of health. Therefore, not only sufficient sleep time is necessary for maintaining good health in both mental state and physical state, but also good quality of sleep is significant to health.

Therefore, it is important to choose and use a bed. Various bed assemblies are commercially available on market. These bed assemblies have different mattresses made of different materials with different functions. Also, the bed frames of the bed assemblies are specifically designed with different configurations in accordance with the functions of the mattresses. For example, some people will lie on the beds to watch TV programs. However, a common mattress and bed frame are fixed in a horizontal state without possibility of changing inclination as necessary. Therefore, some manufactures have developed a kind of bed frames, which are changeable in angle. Such bed frame is composed of multiple parts arranged at suitable intervals. A power unit is additionally mounted under the bed frame, for changing the angle thereof. Also, the mattress on the bed frame is changeable in angle.

The assembling process of the bee frames includes many steps. First, it is necessary to place the bed frame wrapping layer on the ground in a plane state. Then, the bed frames are symmetrically rested on and attached to the bed frame wrapping layer in parallel to each other at suitable intervals. When locating the bed frames, it is necessary to precisely pull the bed frame wrapping layer straight into alignment with the locating angles of the respective bed frames. However, when pulling the bed frame wrapping layer straight, it is hard to effectively fix the bed frames. As a result, the bed frames tend to displace from their true positions . Under such circumstance, it is necessary to rearrange the bed frames until the bed frame wrapping layer is pulled straight and the bed frames are precisely fixed. After the bed frame wrapping layer is located on the bed frames, the bee frames with the bed frame wrapping layer are turned. At this time, the bed frames are apt to displace from their true positions due to drag of the bed frame wrapping layer. Accordingly, it is laborious and time-consuming to assemble the bed frames and the bed frame wrapping layer. Moreover, after fixed, the bed frames still tend to deflect or displace relative to each other. As a result, the ratio of defective products is very high. According to the aforesaid, the conventional assembling process for bed assembly has the following shortcomings:
1. Great labor is consumed.
2. The working time is longer.
3. It is inconvenient to assemble the bed frames and the bed frame wrapping layer.
4. The ratio of defective products is relatively high.

### SUMMARY OF THE INVENTION

A primary object of the present invention is to provide an assembling device for bed assembly, which includes a rest assembly for precisely locating the bed frames. With the assembling device, the bed assembly can be assembled at lower ratio of defective products.

A further object of the present invention is to provide the above assembling device for bed assembly, which further includes a bracket on which the rest assembly is mounted. With the assembling device, the bed assembly can be more quickly and conveniently assembled.

To achieve the above and other objects, the assembling device for bee assembly of the present invention includes a main stand, a bracket and a rest assembly. The bracket is fixedly disposed on the main stand and extends from the main stand. At least one support member is disposed on the bracket and upward extends therefrom. The rest assembly is mounted on the bracket and has at least one locating board, for conveniently resting one or more bed frames thereon and quickly assembling the bed frames at lower ratio of defective products. After assembled, the bed assembly is conveniently carried away from the assembling device.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of a first embodiment of the present invention;

FIG. 2 is a perspective view showing the use of the first embodiment of the present invention at a first stage;

FIG. 3 is a perspective view showing the use of the first embodiment of the present invention at a second stage;

FIG. 4 is a perspective view of a second embodiment of the present invention;

FIG. 5 is a perspective view of a part of the second embodiment of the present invention;

FIG. 6 is a perspective view showing the use of the second embodiment of the present invention at a first stage;

FIG. 7 is a perspective view of a part of the second embodiment of the present invention according to FIG. 6;

FIG. 8 is a perspective view showing the use of the second embodiment of the present invention at a second stage;

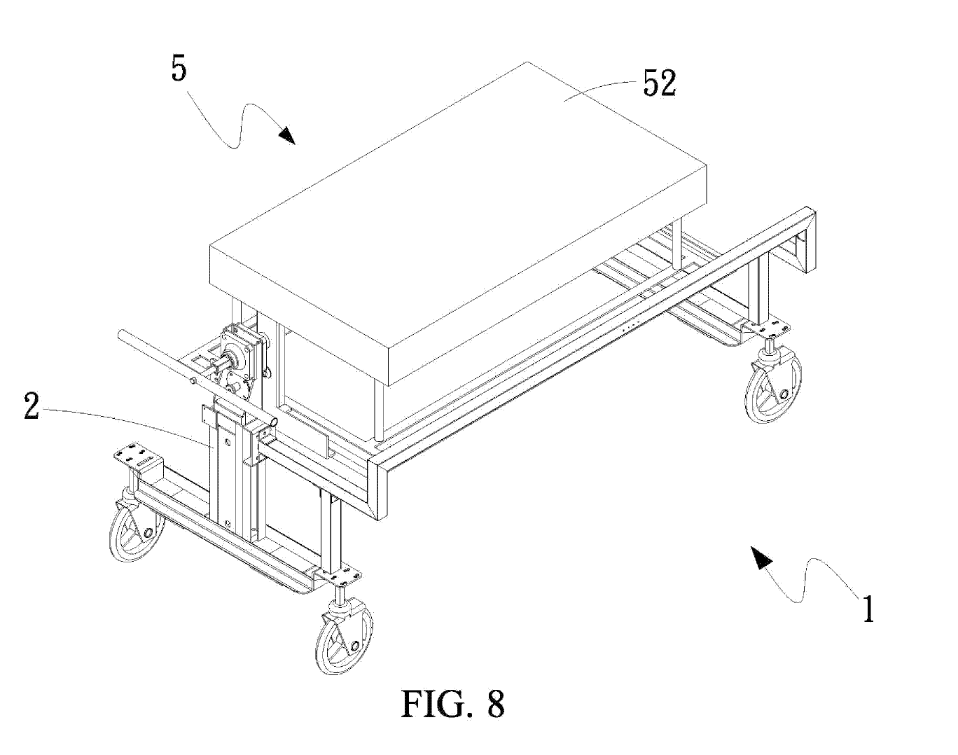

FIG. 9 is a perspective view showing the use of the second embodiment of the present invention at a third stage;

FIG. 10 is a perspective view showing the use of the second embodiment of the present invention at a fourth stage;

FIG. 11 is a perspective view showing the use of the second embodiment of the present invention at a fifth stage;

FIG. 12 is a perspective view showing the use of the second embodiment of the present invention at a sixth stage;

FIG. 13 is a perspective view of a third embodiment of the present invention;

FIG. 14 is a perspective view of a part of the third embodiment of the present, invention;

FIG. 15 is a perspective view showing the use of the third embodiment of the present invention at a fourth stage as seen in another direction;

FIG. 16 is a perspective view showing the use of the third embodiment of the present invention at a fifth stage as seen in the other direction; and

FIG. 17 is a perspective view showing the use of the third embodiment of the present invention at a sixth stage as seen in the other direction.

### DETAILED DESCRIPTION OF THE PREFERRED EMBODIMENTS

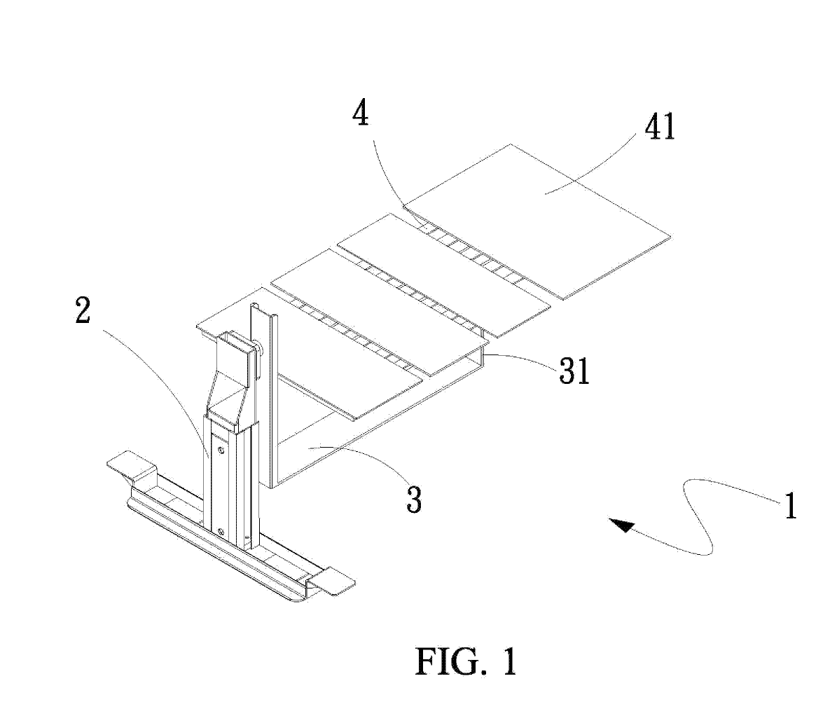

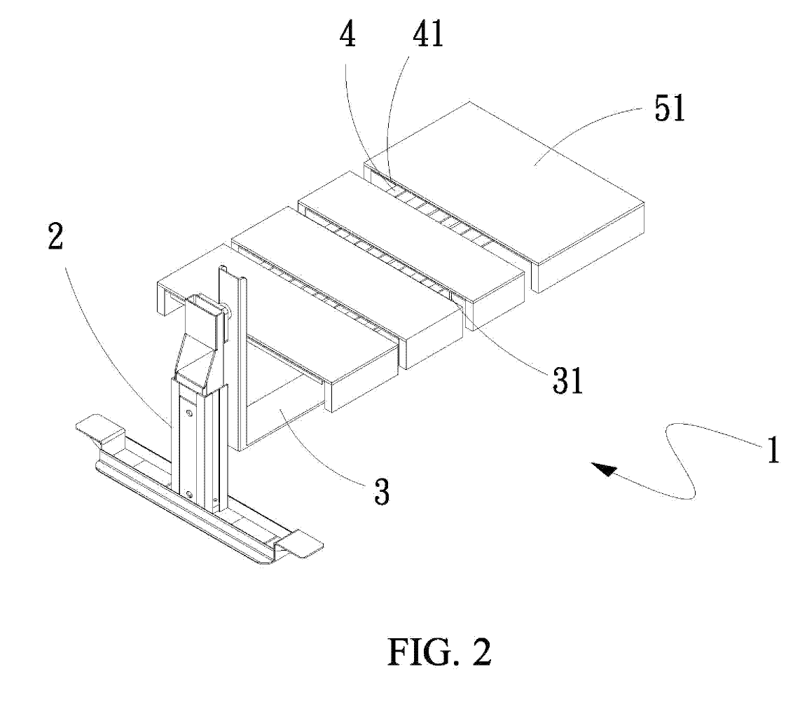

Please refer to FIGS. 1, 2 and 3. According to a first embodiment, the assembling device 1 of the present invention includes a main stand 2, a bracket 3 and a rest assembly 4. The main stand 2 is kept stationary and the bracket 3 is fixedly disposed on the main stand 2. One end of the bracket 3 is fixed on the main stand 2, while the other end of the bracket 3 outward horizontally extends from the main stand 2. At least one support member 31 is disposed on the bracket 3 and upward extends therefrom. The rest assembly 4 is mounted on the bracket 3. The rest assembly 4 has at least one locating board 41. The locating boards 41 are symmetrically arranged in parallel to each other. The bed frames 51 of the bed assembly 5 are supported on the rest assembly 4 respectively corresponding to the locating boards 41. By means of the locating boards 41, the bed frames 51 are prevented from deflecting or displacing relative to each other. After the bed frames 51 are located, a bee frame wrapping layer 52 is laid over the bed frames 51 to enclose and fix the bed frames 51. When fixed, the bed frames 51 will not displace or deflect due to drag of the bed frame wrapping layer 52. Accordingly, the bed frames 51 and the bed frame wrapping layer 52 can be quickly and precisely located without repeated working.

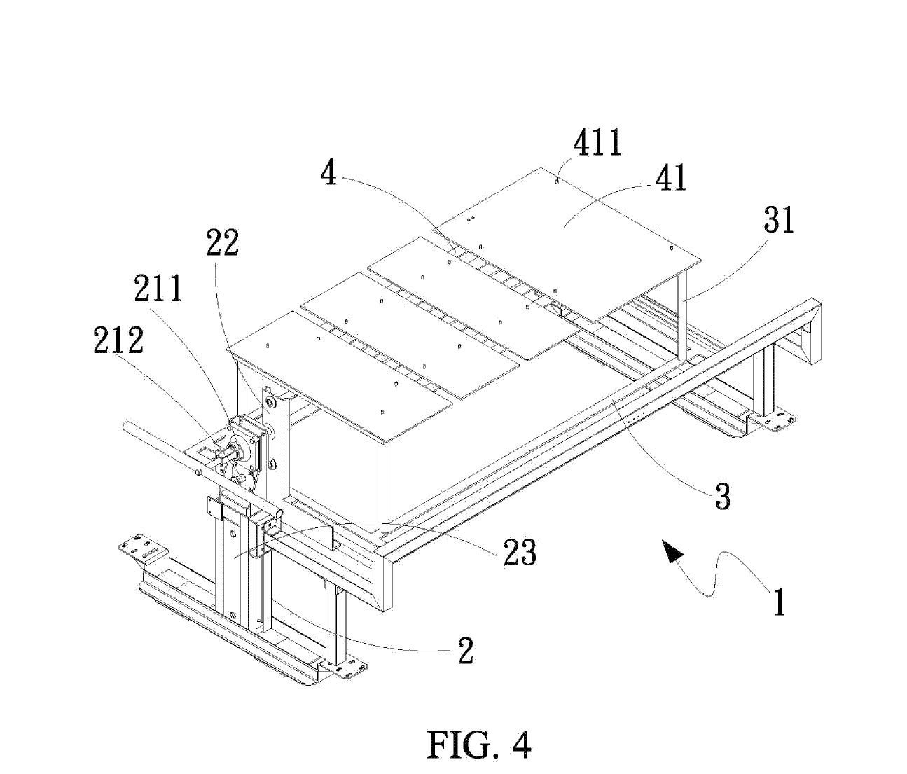

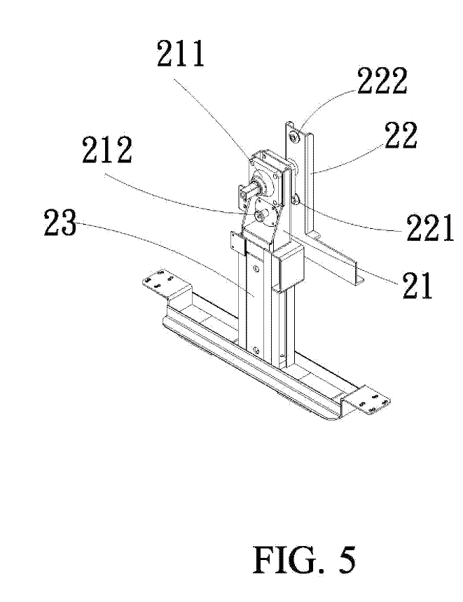

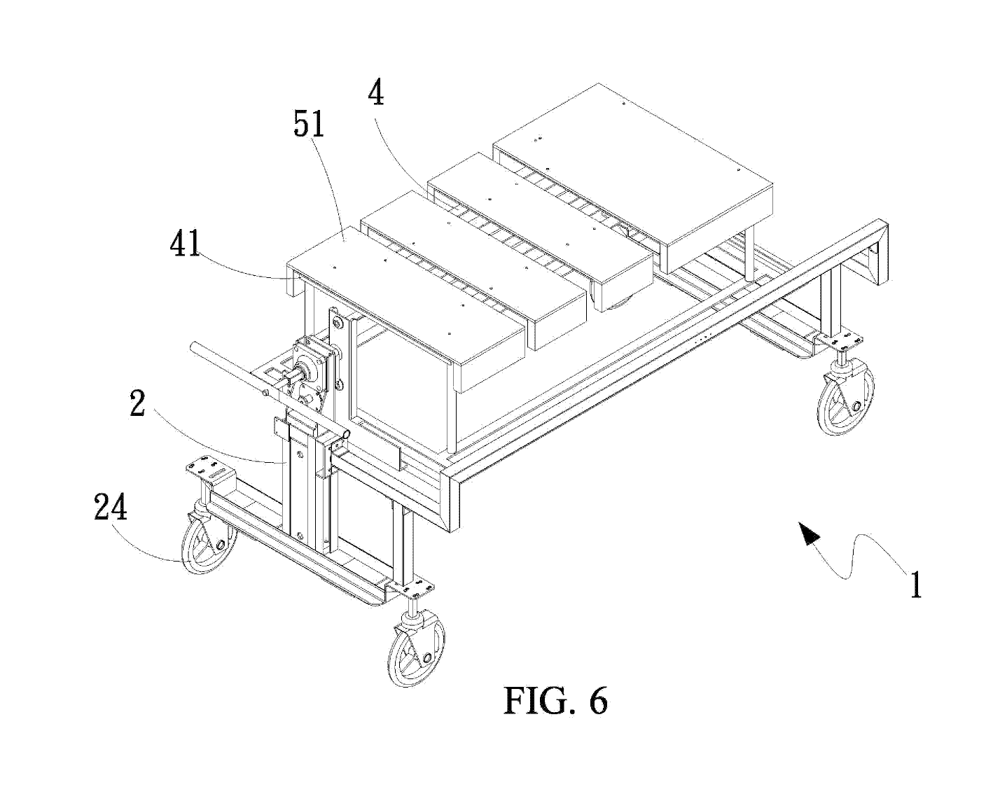

Please now refer to FIGS. 4, 5 and 6. According to a second embodiment, a first operation assembly 21 is mounted on the main stand 2. The first operation assembly 21 includes a first operation member 211 and a second operation member 212. A first swinging member 22 is arranged on one side of the first operation member 211 and connected therewith. The first swinging member 22 has a first through hole 221 and a second through hole 222 selectively in alignment with the second operation member 212. The second operation member 212 is detachably engaged in the first through hole 221 of the first swinging member 22. The first operation assembly 21 is mounted on the main stand 2. An elevation unit 23 is mounted on the main stand 2 for driving the first operation assembly 21 to move up and down along the main stand 2. The bracket 3 has a first end fixed with the first swinging member 22 of the first operation assembly 21 and extends from the first swinging member 22. At least one support member 31 is mounted on the bracket 3 and upward extends therefrom. The rest assembly 4 is mounted on the support member 31. The rest assembly 4 has at least one locating board 41. At least one locating member 411 protrudes from the locating board 41. In addition, several casters 24 are mounted under the main stand 2 for easily moving the assembling device 1.

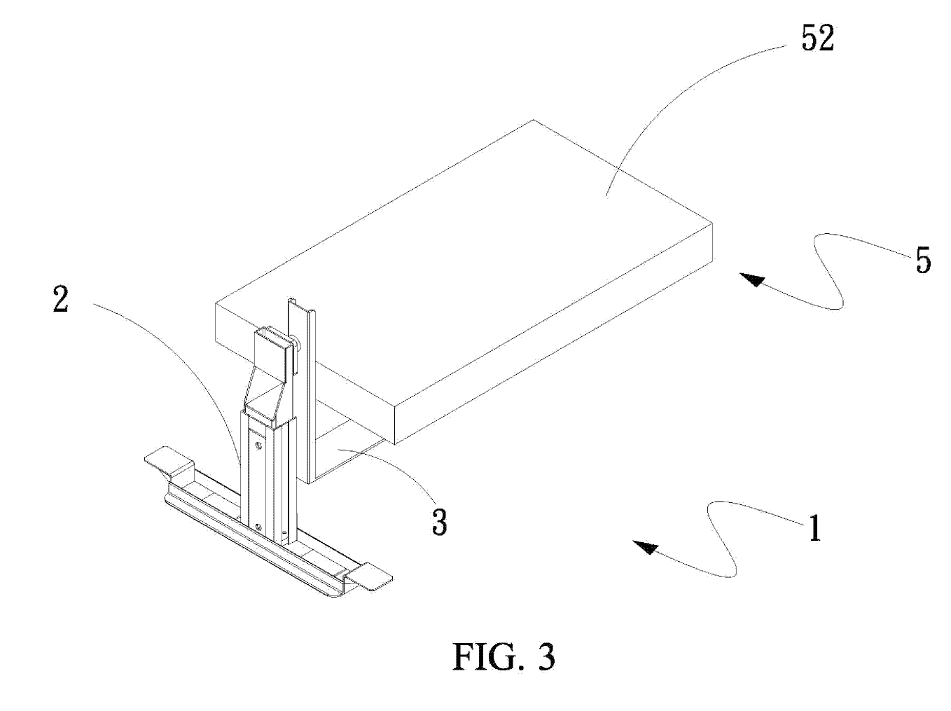

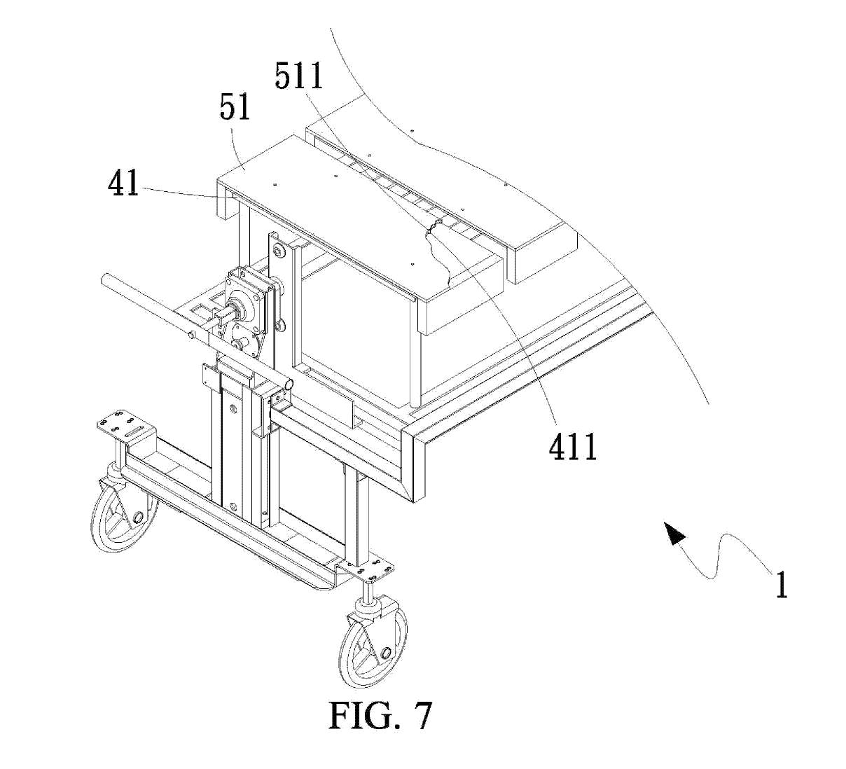

Referring to FIGS. 5, 7 and 3, the bed frames 51 of the bed assembly 5 are supported on the rest assembly 4 respectively corresponding to the locating boards 41. An inner face of each bed frame 51 is formed with at least one recessed locating hole 511 corresponding to the locating member 421 of the locating board 41. When the bed frames 51 is supported on the locating board 41, the locating members 422 are fitted in the locating holes 511 to prevent the bee frames 51 from deflecting or displacing from the locating board 41. After the bed frames 51 are located, the bed frame wrapping layer 52 is laid over the bed frames 51 to enclose and fix the bed frames 51. When fixed, the bed frames 51 will not displace or deflect due to drag of the bed frame wrapping layer 52. Accordingly, the bed frames 51 and the bed frame wrapping layer 52 can be quickly and precisely located without repeated working.

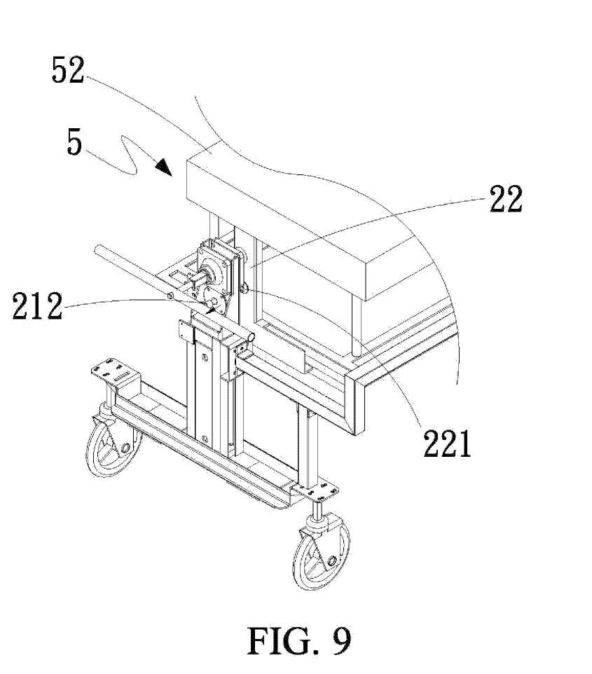

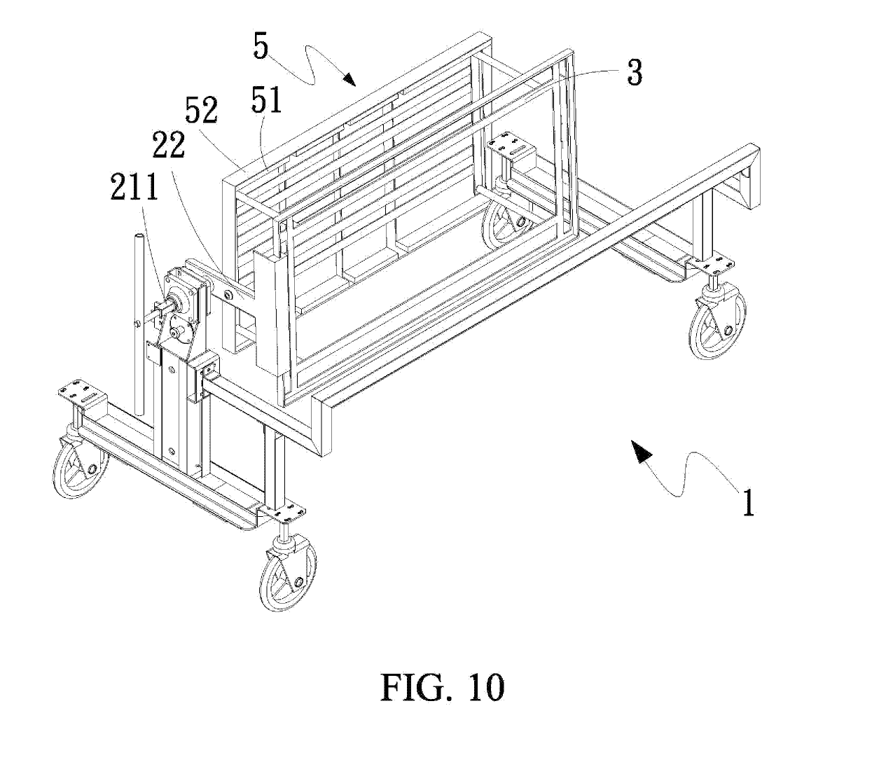

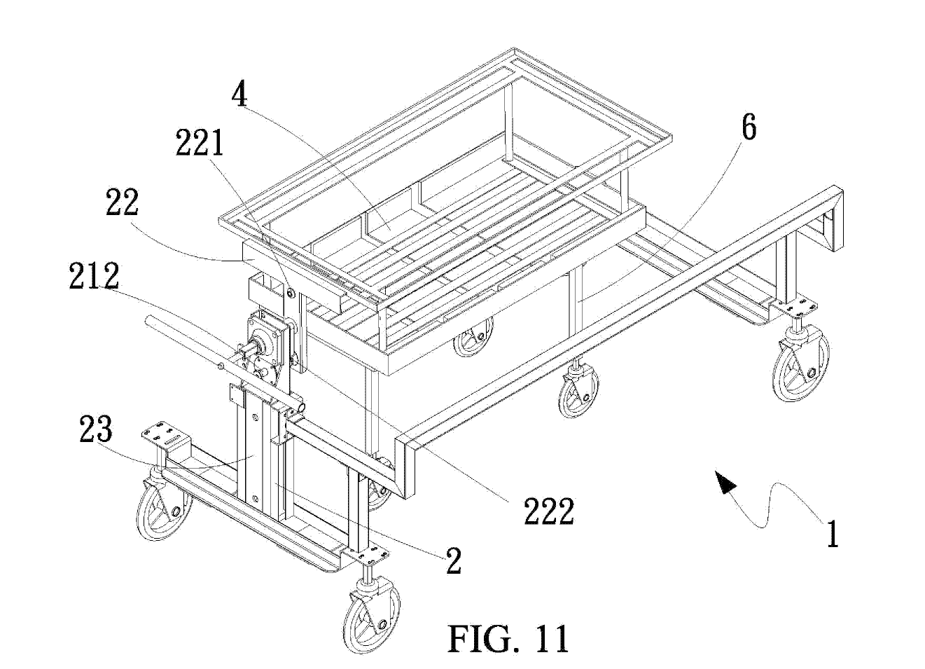

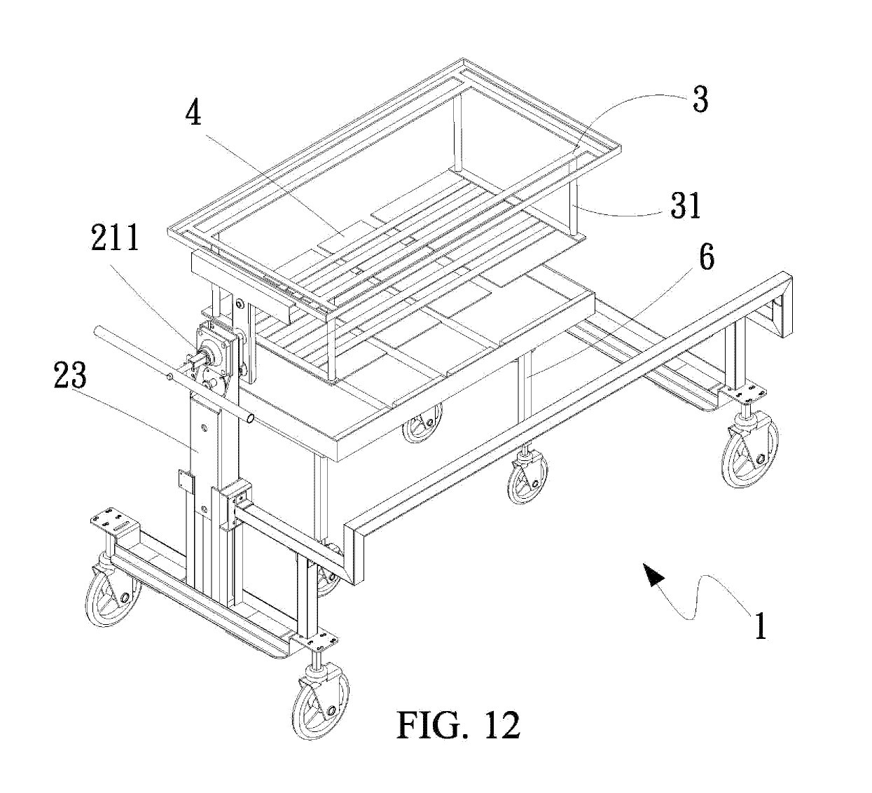

Referring to FIGS. 9 to 12, after the bed frame wrapping layer 52 fixedly encloses the bed frames 51 to form the bed assembly 5, the second operation member 212 is moved in a back-and-forth manner and extracted out of the first through hole 221 of the first swinging member 22 to release the first swinging member 22. In this case, a hand tool can be used to rotate the first operation member 221. At this time, the first swinging member 22 is driven and rotated with the first operation member 211. Also, the bracket 3 and the bed assembly 5 are rotated with the first swinging member 22 until the second through hole 222 of the first swinging member 22 moves to the position of the second operation member 212. At this time, the second operation member 212 resiliently restores to its home position and is automatically inserted into the second through hole 222 to fix the first swinging member 22. Under such circumstance, the bracket 3 is located with the first swinging member 22. In this case, the bracket 3 ad the rest assembly 4 are held in an upside-down state, whereby a carrier 6 can be placed under the bracket 3 for resting the bed assembly 5 on the carrier 6. Then, the elevation unit 23 of the main stand 2 is activated to drive and ascend the first operation assembly 21 along the main stand 2. At the same time, the rest assembly 4 and the bed assembly 5 supported on the support members 31 of the bracket 3 are ascended along with the first operation assembly 21 to separate the bed assembly 5 from the rest assembly 4. Thereafter, the bed assembly 5 is carried away from the assembling device 1 with the carrier 6. Accordingly, the bed assembly b can be quickly assembled with lower ratio of defective products to save labor and working time. After the bed assembly 5 is carried away from the assembling device 1 with the carrier 6, the second operation member 212 is moved in a back-and-forth manner and extracted out of the second through hole 222 of the first swinging member 22 to release the first swinging member 22. In this case, a hand tool can be used to rotate the first operation member 211 in a reverse direction until the first through hole 221 of the first swinging member 22 moves to the position of the second operation member 212 for assembling the bee frames 51 are the bed frame wrapping layer 52 into another bed assembly 5. After the bed assembly 5 is carried away from the assembling device 1 with the carrier 6, the elevation unit 23 of the main stand 2 drives and descends the first operation assembly 21 along the main stand 2. Then the second operation member 212 is moved in a back-and-forth manner and extracted out of the second through hole 222 of the first swinging member 22 to release the first swinging member 22. In this case, a hand tool can be used to rotate the first operation member 211 in a reverse direction until the first through hole 221 of the first swinging member 22 moves to the position of the second operation member 212 for assembling the bed frames 51 and the bed frame wrapping layer 52 into another bed assembly 5. Accordingly, the bed assembly 5 can be quickly assembled.

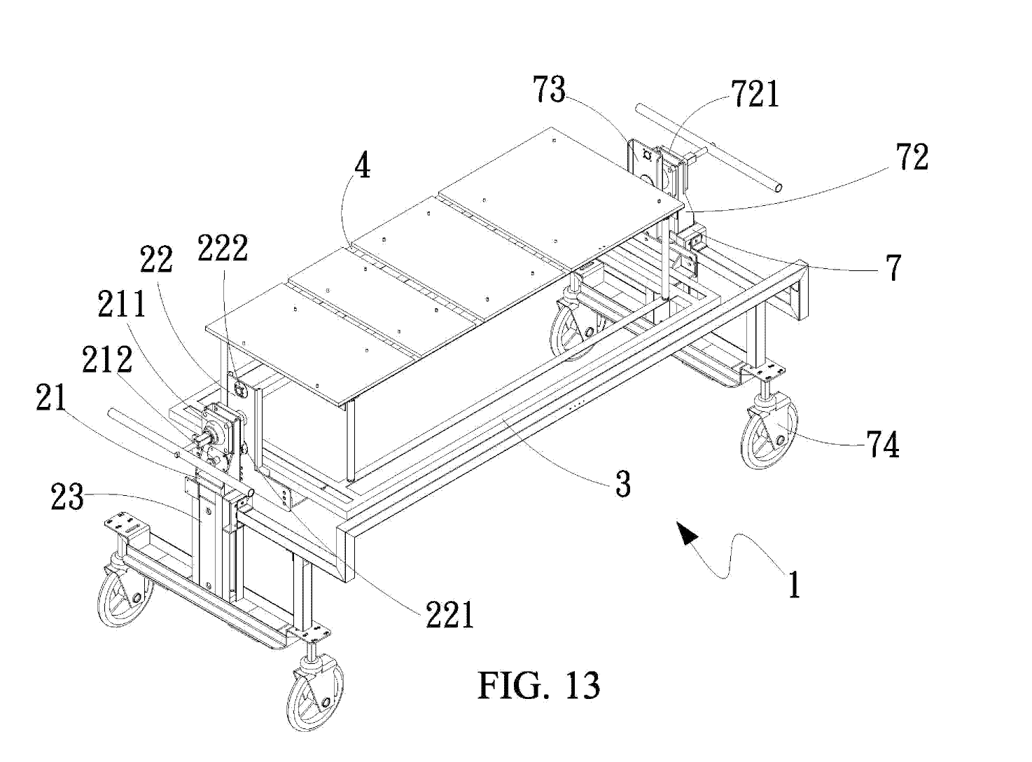

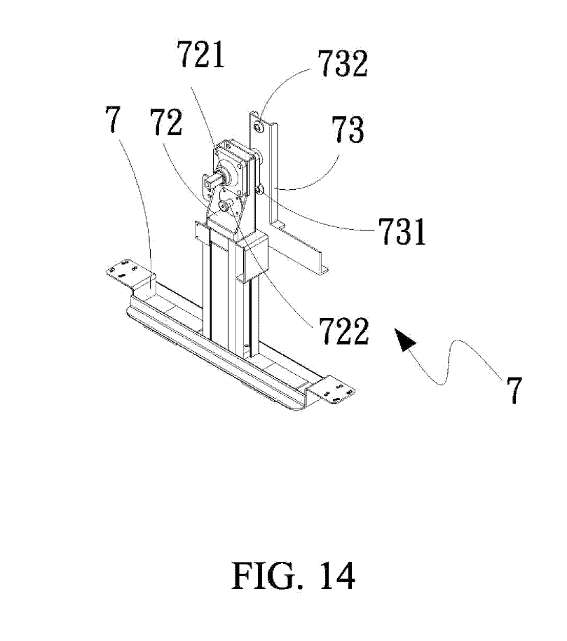

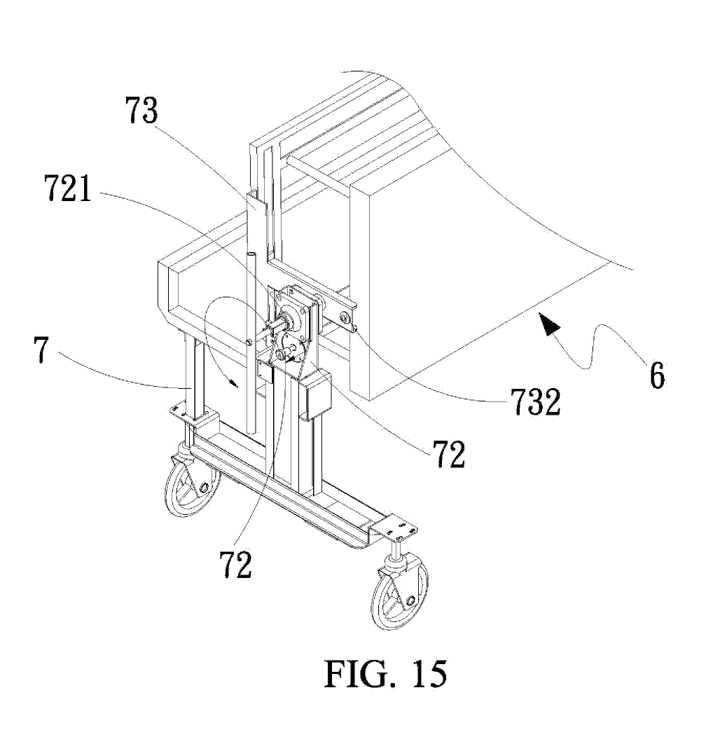

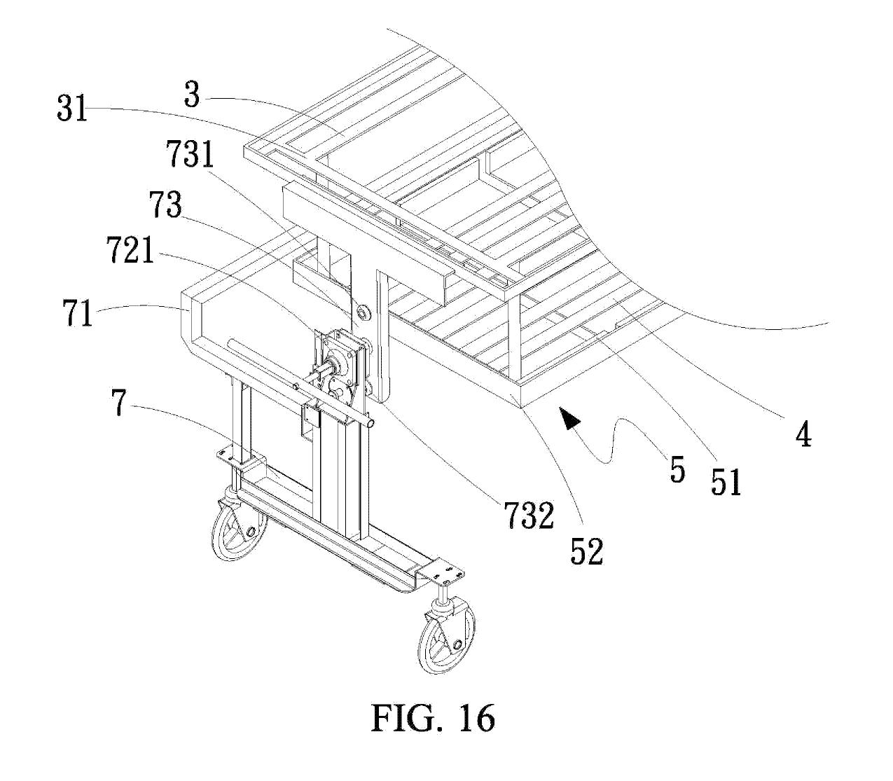

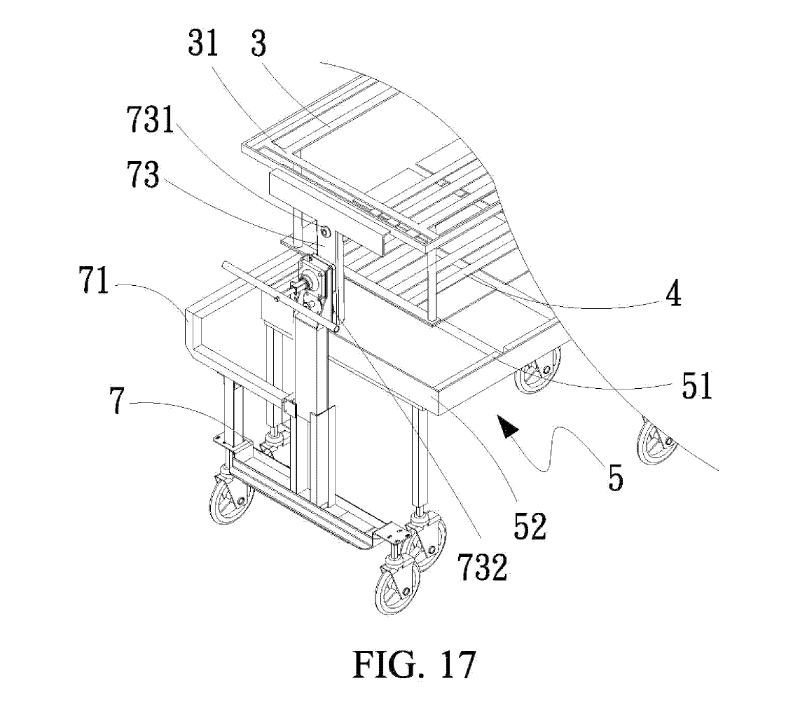

FIGS. 13 to 17 show a third embodiment of the present invention, in which the assembling device 1 further includes a subsidiary stand 7 arranged opposite to the main stand 2. The main stand 2 and the subsidiary stand 7 are interconnected by means of a connection member 71. A second operation assembly 72 is disposed on the subsidiary stand 7, whereby the assembling device 1 can be operated at two ends thereof to facilitate assembling process of the bed assembly 5. The second operation assembly 72 includes a third operation member 721 and a fourth operation member 722. A second swinging member 73 is arranged on one side of the third operation member 721. A second end of the bracket 3 is fixed with the second swinging member 73. The second operation assembly 72 is mounted on the subsidiary stand 7. Several casters 74 are mounted under the subsidiary stand 7 for easily moving the assembling device 1. The bed frames 51 are rested on the rest assembly 4. After the bed frame wrapping layer 52 fixedly encloses the bed frames 51 to form the bed assembly 5, the second operation member 212 is extracted out of the first through hole 221 of the first, swinging member 22 and the fourth operation member 722 is extracted out of a third through hole 731 of the second swinging member 73 to release the first swinging member 22 and the second swinging member 72. In this case, a hand tool can be used to rotate the first operation member 211 and the third operation member 721 to rotate the bracket 3 and the bed assembly 5 as aforesaid until the second through hole 222 of the first swinging member 22 moves to the position of the second operation member 212 and a fourth through hole 732 of the second swinging member 73 moves the position of the fourth operation member 722. At this time, the second operation member 212 and the fourth operation member 722 are automatically respectively inserted into the second through hole 222 and the fourth through hole 732 to fix the first and second swinging members 22, 73 and the bracket 3. In this case, the bracket 3 and the rest assembly 4 are held in an upside-down state, whereby a carrier 6 can be placed under the bracket 3 for resting the bed assembly 5 on the carrier 6. Then, the elevation unit 23 of the main stand 2 is activated to drive and ascend the first and second operation assemblies 21, 72 along the main stand 2 and the subsidiary stand 7 to separate the bed assembly 5 from the rest assembly 4. Thereafter, the bed assembly 5 is carried away from the assembling device 1 with the carrier 6. Accordingly, the bed assembly 5 can be quickly assembled with lower ratio of defective products.

In conclusion, the ace circling device for bed assembly of the present invention has the following advantages:
1. The bed frames can be precisely fixedly located.
2. The ratio of defective products is lowered.
3. The bed assembly can be conveniently and quickly assembled.
4. The labor is saved and the working time is shortened.

The present invention has been described with some preferred embodiments thereof and it is understood that many changes and modifications in the described embodiments can be carried cut without departing from the scope and the spirit of the invention that is intended to be limited only by the appended claims.

What is claimed is:

1. An assembling device for bed assembly, comprising:
a main stand;
a bracket fixedly disposed on the main stand and extending from, the main stand, at least one support member being disposed on the bracket; and
a rest assembly mounted on the bracket and having at least one locating board.

2. The assembling device for bed assembly as claimed in claim 1, wherein the locating boards are symmetrically arranged in parallel to each other.

3. The assembling device for bed assembly as claimed in claim 1, wherein a first operation assembly is mounted on the main stand.

4. The assembling device for bed assembly as claimed in claim 3, wherein the first operation assembly includes a first operation member, a second operation member and a first swinging member, the first operation member being connected with the first swinging; member, the second operation member being detachably engaged with the first swinging member.

5. The assembling device for bed assembly as claimed in claim 4, wherein the bracket has a first end fixed with the first swinging member and extends from the first swinging member, whereby when rotating the first operation member, the first swinging member and the bracket are rotated along with the first, operation member.

6. The assembling device for bed assembly as claimed in claim 4, wherein the first swinging member has a first through hole and a second through hole selectively in alignment with the second operation member, the second operation member being back and forth movable to engage in one of the first through hole and the second through hole.

7. The assembling device for bed assembly as claimed in claim 1, wherein several casters are mounted under the main stand.

8. The assembling device for bed assembly as claimed in claim 3, wherein an elevation unit is mounted on the main stand for driving the first operation assembly to move up and down along the main stand.

9. The assembling device for bed assembly as claimed in claim 1, wherein the locating board is for resting one or mere bed frames, thereon an intervals.

10. The assembling device for bed assembly as claimed in claim 9, wherein at least one locating member protrudes from the locating board, the bed frame being formed with at least one locating hole, whereby when the bed frame is supported on the locating board, the locating member is fitted in the locating hole to locate the bed frame.

11. The assembling device for bed assembly as claimed in claim 1, wherein a second end of the bracket is mounted on a subsidiary stand.

12. The assembling device for bed assembly as claimed in claim 11, wherein the subsidiary stand and the main stand are interconnected by means of a connection member.

13. The assembling device for bed assembly as claimed in claim 11, wherein a second operation assembly is mounted on the subsidiary stand.

14. The assembling device for bed assembly as claimed in claim 13, wherein the second operation assembly includes a third operation member, a fourth operation member and a second swinging member.

15. The assembling device for bed assembly as claimed in claim 14, wherein the second end of the bracket is fixed with the second swinging member.

16. The assembling device for bed assembly as claimed in claim 4, wherein the second swinging member has a third through hole and a fourth through hole selectively in alignment with the fourth operation member, the fourth operation member being back and forth movable to engage in one of the third through hole and the fourth through hole.

17. The assembling device for bed assembly as claimed in claim 11, wherein several casters ere mounted under the subsidiary stand.
